(19) United States
(12) Patent Application Publication
(10) Pub. No.: US 2022/0118612 A1
(43) Pub. Date: Apr. 21, 2022

(54) INFERENCE DEVICE, APPARATUS CONTROL SYSTEM, AND LEARNING DEVICE

(71) Applicant: Mitsubishi Electric Corporation, Tokyo (JP)

(72) Inventor: Tomoaki OIKI, Tokyo (JP)

(73) Assignee: Mitsubishi Electric Corporation, Tokyo (JP)

(21) Appl. No.: 17/564,570

(22) Filed: Dec. 29, 2021

Related U.S. Application Data
(63) Continuation of application No. PCT/JP2019/034963, filed on Sep. 5, 2019.

(51) Int. Cl. B25J 9/16; G05B 13/02

(52) U.S. Cl. CPC B25J 9/163; G05B 13/027

(57) ABSTRACT

An inference device includes: a feature amount extractor to receive an input of a state value related to an environment including both a control device and an apparatus controlled by the control device, and output a feature vector corresponding to the state value and having a higher dimension than that of the state value; and a controller 4 to receive an input of the feature vector and output a control amount corresponding to the feature vector.

### CROSS REFERENCE TO RELATED APPLICATIONS

This application is a Continuation of PCT International Application No. PCT/JP2019/034963 filed on Sep. 5, 2019, which is hereby expressly incorporated by reference into the present application.

### TECHNICAL FIELD

The present invention relates to an inference device, an apparatus control system, and a learning device.

### BACKGROUND ART

Conventionally, a technique of applying so-called “reinforcement learning” to image processing or the like has been developed (See, for example, Patent Literature 1). Usually, in reinforcement learning related to image processing or the like, the number of state values obtained from an image or the like is large. That is, the number of dimensions of a feature vector obtained from the image or the like is large. Therefore, a feature amount extractor is used from the viewpoint of reducing the number of dimensions of a feature vector input to an agent with respect to the number of dimensions of a feature vector obtained from an image or the like. This is to avoid a decrease in learning efficiency and inference efficiency due to an excessively large number of dimensions of the feature vector input to the agent. In other words, this is to improve learning efficiency and inference efficiency.

### CITATION LIST

### Patent Literatures

Patent Literature 1: WO 2017/019555 A

### SUMMARY OF INVENTION

### Technical Problem

In recent years, a technology for applying reinforcement learning to operation control of an apparatus (for example, a robot or an autonomous vehicle) has been developed. Usually, the number of state values obtained from an environment including an apparatus is smaller than the number of state values obtained from an image or the like. That is, the number of dimensions of a feature vector obtained from the environment including the apparatus is smaller than the number of dimensions of a feature vector obtained from the image or the like. For this reason, in the reinforcement learning related to the operation control of the apparatus, there is a problem that learning efficiency and inference efficiency cannot be improved by using the same feature amount extractor as the conventional feature amount extractor.

Hereinafter, in controlling the operation of an apparatus by reinforcement learning, the learning efficiency, the inference efficiency, or the operation efficiency of the apparatus may be collectively simply referred to as “efficiency”.

The present invention has been made to solve the above problems, and an object thereof is to improve efficiency in controlling the operation of an apparatus by reinforcement learning.

### Solution to Problem

An inference device of the present invention includes: feature amount extracting circuitry to receive an input of a state value related to an environment including both a control device and an apparatus controlled by the control device, and output a feature vector that corresponds to the state value and has a higher dimension than that of the state value; and controlling circuitry to receive an input of the feature vector and output a control amount corresponding to the feature vector. The feature amount extracting circuitry includes one layer or a plurality of layers, and the one layer or at least one of the plurality of layers has a structure that receives an input of a first vector, generates a second vector by converting the first vector, generates a third vector based on the first vector, generates a fourth vector having a higher dimension than that of the first vector by combining the second vector and the third vector, and outputs the fourth vector.

A learning device of the present invention is a learning device for an inference device, the inference device including first feature amount extracting circuitry to receive an input of a first state value related to an environment including both a control device and an apparatus controlled by the control device, and output a first feature vector that corresponds to the first state value and has a higher dimension than that of the first state value, the learning device including: second feature amount extracting circuitry to receive inputs of the first feature vector and an action value related to the environment, and output a second feature vector that corresponds to the first feature vector and the action value and has a higher dimension than those of the first feature vector and the action value; and learning circuitry to receive inputs of the second feature vector and a second state value related to the environment, and update a parameter of the first feature amount extracting circuitry by using the second feature vector and the second state value.

### Advantageous Effects of Invention

According to the present invention, with the above configuration, it is possible to improve efficiency in controlling the operation of an apparatus by reinforcement learning.

### BRIEF DESCRIPTION OF DRAWINGS

FIG. 1 is a block diagram showing a main part of an apparatus control system according to a first embodiment.

FIG. 2 is an explanatory diagram illustrating an example of a robot controlled by the apparatus control system according to the first embodiment.

FIG. 3 is an explanatory diagram illustrating main parts of a feature amount extractor and a controller in the apparatus control system according to the first embodiment.

FIG. 4A is an explanatory diagram illustrating a structure of each layer in the feature amount extractor in the apparatus control system according to the first embodiment.

FIG. 4B is an explanatory diagram illustrating another structure of each layer in the feature amount extractor in the apparatus control system according to the first embodiment.

FIG. 5A is an explanatory diagram illustrating a hardware configuration of an inference device in the apparatus control system according to the first embodiment.

FIG. 5B is an explanatory diagram illustrating another hardware configuration of the inference device in the apparatus control system according to the first embodiment.

FIG. 6A is an explanatory diagram illustrating a hardware configuration of a control device in the apparatus control system according to the first embodiment.

FIG. 6B is an explanatory diagram illustrating another hardware configuration of the control device in the apparatus control system according to the first embodiment.

FIG. 7 is a flowchart illustrating an operation of the apparatus control system according to the first embodiment.

FIG. 8 is a flowchart illustrating an operation of each layer in the feature amount extractor in the apparatus control system according to the first embodiment.

FIG. 9 is a block diagram showing a main part of a reinforcement learning system according to a second embodiment.

FIG. 10 is an explanatory diagram illustrating main parts of a first feature amount extractor, a second feature amount extractor, a first controller, and a learner in the reinforcement learning system according to the second embodiment.

FIG. 11A is an explanatory diagram illustrating a hardware configuration of a learning device in the reinforcement learning system according to the second embodiment.

FIG. 11B is an explanatory diagram illustrating another hardware configuration of the learning device in the reinforcement learning system according to the second embodiment.

FIG. 12 is a flowchart illustrating an operation of the reinforcement learning system according to the second embodiment.

FIG. 13 is a characteristic diagram illustrating an example of learning characteristics in a reinforcement learning system having a feature amount extractor and an example of learning characteristics in a reinforcement learning system having no feature amount extractor.

FIG. 14 is a block diagram showing a main part of a reinforcement learning system according to a third embodiment.

FIG. 15 is an explanatory diagram illustrating a hardware configuration of a storage device in the reinforcement learning system according to the third embodiment.

### DESCRIPTION OF EMBODIMENTS

Hereinafter, in order to explain this invention in more detail, modes for carrying out this invention will be described by referring to the accompanying drawings.

### First Embodiment

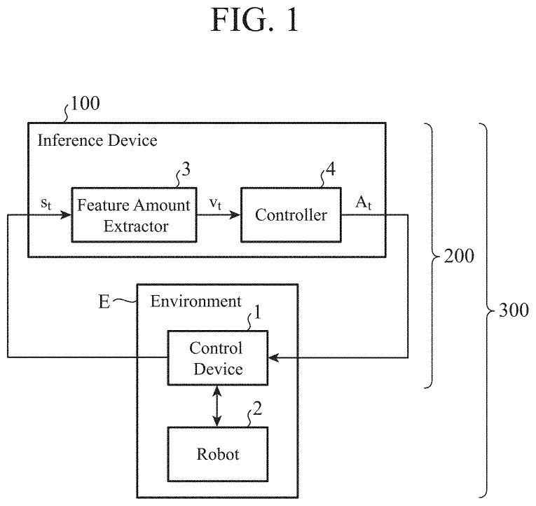

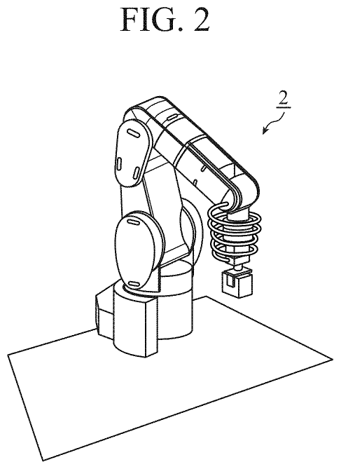

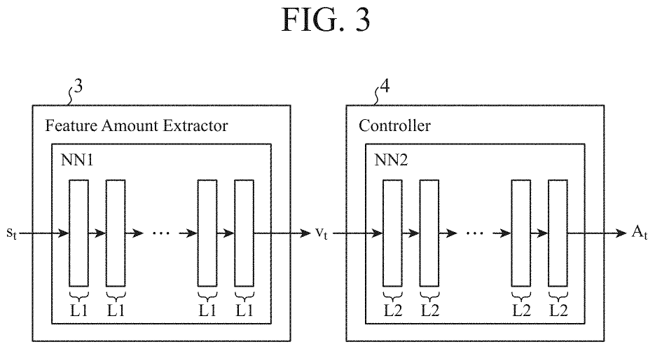

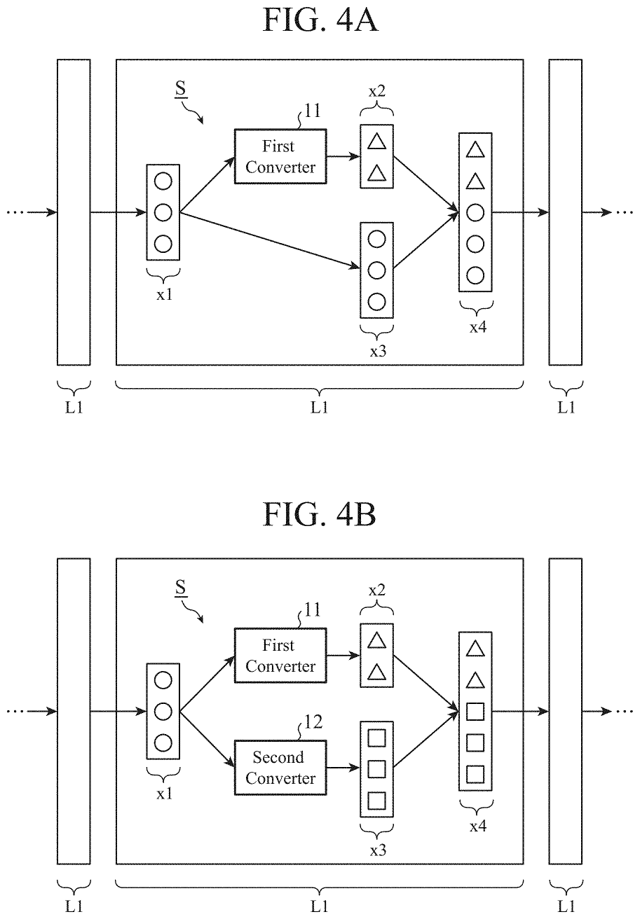

FIG. 1 is a block diagram showing a main part of an apparatus control system according to the first embodiment. FIG. 2 is an explanatory diagram illustrating an example of a robot controlled by the apparatus control system according to the first embodiment. FIG. 3 is an explanatory diagram illustrating main parts of a feature amount extractor and a controller in the apparatus control system according to the first embodiment. FIG. 4A is an explanatory diagram illustrating a structure of each layer in the feature amount extractor in the apparatus control system according to the first embodiment. FIG. 4B is an explanatory diagram illustrating another structure of each layer in the feature amount extractor in the apparatus control system according to the first embodiment. The apparatus control system according to the first embodiment will be described with reference to FIGS. 1 to 4.

As illustrated in FIG. 1, an environment E includes a control device 1 and a robot 2. The control device 1 controls the operation of the robot 2. As illustrated in FIG. 2, the robot 2 includes, for example, a robot arm.

As illustrated in FIG. 1, a loop is formed by the control device 1, a feature amount extractor 3, and a controller 4. The control device 1 outputs a state value st indicating a state of the robot 2. The feature amount extractor 3 receives an input of the output state value sₜ. The feature amount extractor 3 outputs a feature vector vₜ corresponding to the input state value sₜ. The controller 4 receives an input of the output feature vector vₜ. The controller 4 outputs a control amount Aₜ corresponding to the input feature vector vₜ. The control device 1 receives an input of the output control amount Aₜ. The control device 1 controls the operation of the robot 2 using the input control amount Aₜ. As a result, the state of the robot 2 is updated. The control device 1 outputs a state value sₜ indicating the updated state.

The state value sₜ includes, for example, a value indicating a position of a hand of the robot arm and a value indicating speed of the hand of the robot arm. The control amount Aₜ includes, for example, a value indicating torque used for motion control of the robot arm.

As illustrated in FIG. 3, the feature amount extractor 3 includes a neural network NN1. The neural network NN1 has a plurality of layers L1. Each layer L1 is formed of, for example, a so-called “fully connected layer” (hereinafter, referred to as an “FC layer”). Here, each layer L1 has the following structure S.

First, the structure S receives an input of a vector (hereinafter, referred to as a “first vector”) x1 output by the previous layer L1. However, the first vector x1 input to the structure S in the first layer L1 among the plurality of layers L1 is not a vector output by the previous layer L1 but a vector indicating the state value sₜ output by the control device 1.

Second, the structure S generates a vector (hereinafter, referred to as a “second vector”) x2 obtained by converting the input first vector x1. As a result, for example, the second vector x2 having the number of dimensions smaller than the number of dimensions of the first vector x1 is generated. In other words, for example, the second vector x2 having a lower dimension than that of the first vector x1 is generated.

Third, the structure S generates a vector (hereinafter, referred to as a “third vector”) x3 based on the input first vector x1. As a result, for example, the third vector x3 having the same number of dimensions as the number of dimensions of the first vector x1 is generated.

Fourth, the structure S generates a vector (hereinafter, referred to as a “fourth vector”) x4 obtained by combining the generated second vector x2 and the generated third vector x3. As a result, the fourth vector x4 having a larger number of dimensions than the number of dimensions of the first vector x1 is generated. In other words, the fourth vector x4 having a higher dimension than that of the first vector x1 is generated.

Fifth, the structure S outputs the generated fourth vector x4 to the next layer L1. However, the structure S in the last layer L1 among the plurality of layers L1 outputs the generated fourth vector x4 to the controller 4. The fourth vector x4 output by the structure S in the last layer L1 is the feature vector vₜ input to the controller 4.

Each of FIGS. 4A and 4B illustrates an example of the structure S. In the example illustrated in FIG. 4A, the third vector x3 is formed by duplicating the first vector x1. In other words, the third vector x3 is the same vector as the first vector x1. In this case, the structure S executes processing of duplicating the first vector x1 (hereinafter referred to as “duplication processing”). In addition, the structure S includes a learning type converter (hereinafter, referred to as a “first converter”) 11 that executes processing of converting the first vector x1 into the second vector x2 (hereinafter, referred to as “first conversion processing”). The first converter 11 includes, for example, the FC layer.

On the other hand, in the example illustrated in FIG. 4B, the third vector x3 is obtained by converting the first vector x1. In this case, the structure S includes, in addition to the first converter 11, a non-learning type converter (hereinafter, referred to as a “second converter”) 12 that executes processing of converting the first vector x1 into the third vector x3 (hereinafter, referred to as “second conversion processing”). The second converter 12 converts the first vector x1 into the third vector x3 on the basis of a predetermined conversion rule.

Since each layer L1 has the structure S, the number of dimensions of the feature vector vₜ input to the controller 4 can be increased with respect to the number of state values sₜ input to the feature amount extractor 3. As a result, even in a case where the number of state values sₜ obtained from the environment E is small, the high-dimensional feature vector vₜ can be used for inference in the inference device 100. In other words, the amount of information used for inference in the inference device 100 can be increased. As a result, the operation of the robot 2 can be efficiently controlled.

That is, assuming that if a feature amount extractor similar to a conventional feature amount extractor is used in reinforcement learning related to an operation control of an apparatus, the number of dimensions of a feature vector input to an agent is further reduced. The fact that the number of dimensions of the feature vector input to the agent is small means that the amount of information used for inference is small. Therefore, in this case, there is a problem that it is difficult to achieve inference corresponding to a high reward value due to a small amount of information used for inference. As a result, there is a problem that it is difficult to efficiently control the operation of the apparatus.

On the other hand, by using the feature amount extractor 3, as described above, it is possible to increase the amount of information used for inference in the inference device 100. As a result, the operation of the robot 2 can be efficiently controlled. That is, the efficiency can be improved.

Further, the duplication processing is simpler than the learning type first conversion processing. In addition, the non-learning type second conversion processing is simpler than the learning type first conversion processing. Therefore, when the number of dimensions of the feature vector vₜ is increased, the operation amount in the inference device 100 can be reduced by using the duplication processing or the second conversion processing. As a result, inference efficiency in the inference device 100 can be improved.

As illustrated in FIG. 3, the controller 4 includes a neural network NN2. The neural network NN2 has a plurality of layers L2. Each of the layers L2 includes, for example, an FC layer. The controller 4 corresponds to, for example, an “Actor” element in a so-called “Actor-Critic” algorithm. That is, the inference in the inference device 100 is performed by reinforcement learning.

As illustrated in FIG. 1, the feature amount extractor 3 and the controller 4 constitute a main part of the inference device 100. Furthermore, the inference device 100 and the control device 1 constitute a main part of an apparatus control system 200. The apparatus control system 200 and the robot 2 constitute a main part of a robot system 300.

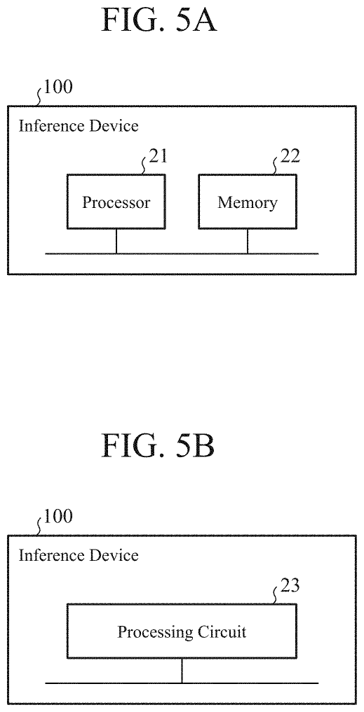

Next, a hardware configuration of the main part of the inference device 100 will be described with reference to FIG. 5.

As shown in FIG. 5A, the inference device 100 has a processor 21 and a memory 22. The memory 22 stores a program for implementing the functions of the feature amount extractor 3 and the controller 4. The processor 21 reads and executes the program, thereby implementing the functions of the feature amount extractor 3 and the controller 4.

Alternatively, as illustrated in FIG. 5B, the inference device 100 includes a processing circuit 23. In this case, the functions of the feature amount extractor 3 and the controller 4 are implemented by a dedicated processing circuit 23.

Alternatively, f the inference device 100 has the processor 21, the memory 22, and the processing circuit 23 (not shown). In this case, some of the functions of the feature amount extractor 3 and the controller 4 are implemented by the processor 21 and the memory 22, and the remaining functions are implemented by the dedicated processing circuit 23.

The processor 21 includes one or a plurality of processors. Each processor is composed of, for example, a Central Processing Unit (CPU), a Graphics Processing Unit (GPU), a microprocessor, a microcontroller, or a Digital Signal Processor (DSP).

The memory 22 includes one or a plurality of nonvolatile memories. Alternatively, the memory 22 includes one or a plurality of nonvolatile memories and one or a plurality of volatile memories. That is, the memory 22 includes one or a plurality of memories. Each memory is composed of, for example, a semiconductor memory, a magnetic disk, an optical disk, a magneto-optical disk, or a magnetic tape. More specifically, each volatile memory is composed of, for example, a Random Access Memory (RAM). In addition, each nonvolatile memory is composed of, for example, a Read Only Memory (ROM), a flash memory, an Erasable Programmable Read Only Memory (EPROM), an Electrically Erasable Programmable Read Only Memory (EEPROM), a solid state drive, a hard disk drive, a flexible disk, a compact disk, a Digital Versatile Disc (DVD), a Blu-ray Disk, or a mini disk.

The processing circuit 23 includes one or a plurality of digital circuits. Alternatively, the processing circuit 23 includes one or a plurality of digital circuits and one or a plurality of analog circuits. That is, the processing circuit 23 includes one or a plurality of processing circuits. Each processing circuit is composed of, for example, an Application Specific Integrated Circuit (ASIC), a Programmable Logic Device (PLD), a Field Programmable Gate Array (FPGA), a System on a Chip (SoC), or a system Large Scale Integration (LSI).

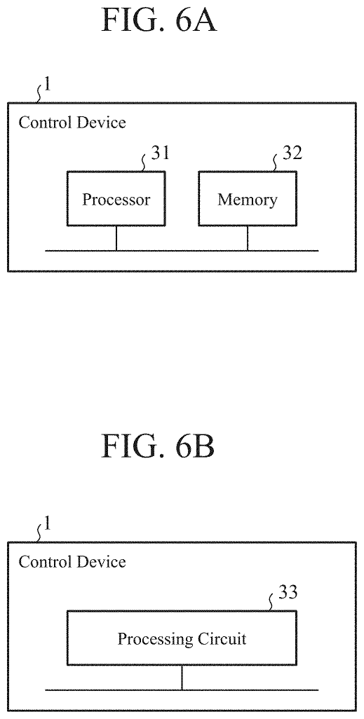

Next, a hardware configuration of the main part of the control device 1 will be described with reference to FIG. 6.

The control device 1 has, as shown in FIG. 6A, a processor 31 and a memory 32. The memory 32 stores a program for implementing functions of the control device 1. The processor 31 reads and executes the program to implement the functions of the control device 1.

Alternatively, as shown in FIG. 6B, the control device 1 has a processing circuit 33. In this case, the functions of the control device 1 are implemented by the dedicated processing circuit 33.

Alternatively, the control device 1 has a processor 31, a memory 32, and a processing circuit 33 (not shown). In this case, some of the functions of the control device 1 are implemented by the processor 31 and the memory 32, and the remaining functions are implemented by the dedicated processing circuit 33.

The processor 31 includes one or a plurality of processors. Each processor uses, for example, a CPU, a GPU, a microprocessor, a microcontroller, or a DSP.

The memory 32 includes one or a plurality of nonvolatile memories. Alternatively, the memory 32 includes one or a plurality of nonvolatile memories and one or a plurality of volatile memories. That is, the memory 32 includes one or a plurality of memories. Each memory is composed of, for example, a semiconductor memory, a magnetic disk, an optical disk, a magneto-optical disk, or a magnetic tape. More specifically, each volatile memory uses, for example, a RAM. In addition, each nonvolatile memory uses, for example, a ROM, a flash memory, an EPROM, an EEPROM, a solid state drive, a hard disk drive, a flexible disk, a compact disk, a DVD, a Blu-ray disk, or a mini disk.

The processing circuit 33 includes one or a plurality of digital circuits. Alternatively, the processing circuit 33 includes one or a plurality of digital circuits and one or a plurality of analog circuits. That is, the processing circuit 33 includes one or a plurality of processing circuits. Each processing circuit uses, for example, ASIC, PLD, FPGA, SoC, or system LSI.

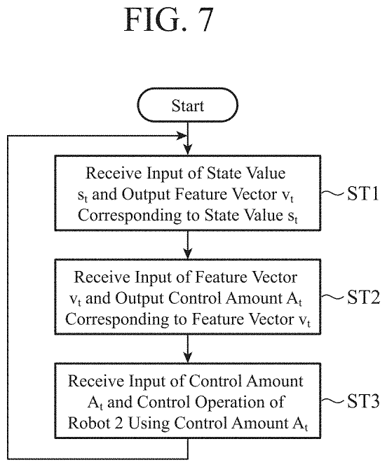

Next, the operation of the apparatus control system 200 will be described with reference to a flowchart of FIG. 7. When the control device 1 outputs the state value st, the processing of step ST1 is executed.

First, the feature amount extractor 3 receives an input of the state value sₜ and outputs a feature vector vₜ corresponding to the input state value sₜ (step ST1). Next, the controller 4 receives an input of the feature vector vₜ and outputs the control amount Aₜ corresponding to the input feature vector vₜ (step ST2). Next, the control device 1 receives an input of the control amount Aₜ and controls the operation of the robot 2 using the input control amount Aₜ (step ST3).

The control device 1 controls the operation of the robot 2 to update the state of the robot 2. The control device 1 outputs a state value sₜ indicating the updated state. As a result, the processing of the apparatus control system 200 returns to step ST1. Hereinafter, the processing of steps ST1 to ST3 is repeatedly executed.

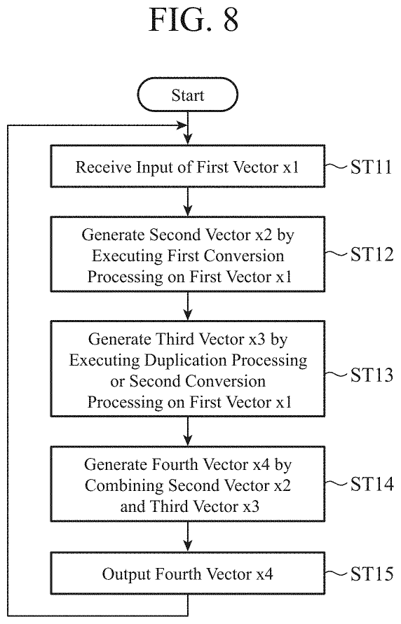

Next, the operation of the individual layers L1 in the feature amount extractor 3 will be described with reference to the flowchart of FIG. 8. That is, the operation of the structure S will be described.

First, the structure S receives an input of the first vector x1 (step ST11). Next, the structure S executes the first conversion processing on the first vector x1 to generate the second vector x2 (step ST12). Next, the structure S executes the duplication processing or the second conversion processing on the first vector x1 to generate the third vector x3 (step ST13). Next, the structure S generates the fourth vector x4 by combining the second vector x2 and the third vector x3 (step ST14). Next, the structure S outputs the fourth vector x4 (step ST15).

Next, a modification of the apparatus control system 200 will be described.

The number of layers L1 and the number of layers L1 having the structure S in the neural network NN1 are not limited to the above specific examples. The number is only required to be set so that the number of dimensions of the feature vector vₜ input to the controller 4 is larger than the number of state values sₜ input to the feature amount extractor 3.

For example, as described above, the neural network NN1 may have a plurality of layers L1, and each of the plurality of layers L1 may have the structure S. Alternatively, for example, the neural network NN1 may have one layer L1 instead of the plurality of layers L1, and the one layer L1 may have the structure S.

Alternatively, for example, the neural network NN1 may have a plurality of layers L1, and each of two or more selected layers L1 among the plurality of layers L1 may have the structure S. In this case, each of the remaining one or more layers L1 among the plurality of layers L1 may not have the structure S.

Alternatively, for example, the neural network NN1 may have a plurality of layers L1, and a selected one of the plurality of layers L1 may have the structure S. In this case, each of the remaining one or more layers L1 among the plurality of layers L1 may not have the structure S.

However, from the viewpoint of further increasing the amount of information used for inference in the inference device 100, it is preferable to increase the number of layers L1 having the structure S. Therefore, it is preferable that a plurality of layers L1 is provided for the neural network NN1 and the structure S is provided for each of the plurality of layers L1.

Furthermore, the number of layers L2 in the neural network NN2 is not limited to the above specific example. The neural network NN2 may have one layer L2 instead of the plurality of layers L2. That is, the inference in the inference device 100 may be performed by so-called “deep type” reinforcement learning. Alternatively, the inference in the inference device 100 may be performed by non-deep type reinforcement learning.

Furthermore, the hardware of the control device 1 may be configured integrally with the hardware of the inference device 100. That is, the processor 31 illustrated in FIG. 6A may be integrated with the processor 21 illustrated in FIG. 5A. The memory 32 illustrated in FIG. 6A may be configured integrally with the memory 22 illustrated in FIG. 5A. The processing circuit 33 illustrated in FIG. 6B may be configured integrally with the processing circuit 23 illustrated in FIG. 5B.

The control target of the control device 1 is not limited to the robot 2. The control device 1 may control the operation of any apparatus. For example, the control device 1 may control the operation of a self-driving vehicle.

As described above, the inference device 100 includes: the feature amount extractor 3 that receives the input of the state value sₜ related to the environment E including both the control device 1 and the apparatus (for example, the robot 2) controlled by the control device 1, and outputs the feature vector vₜ corresponding to the state value sₜ and having a higher dimension than that of the state value sₜ; and the controller 4 that receives the input of the feature vector vₜ and outputs the control amount Aₜ corresponding to the feature vector vₜ. By using the feature amount extractor 3, it is possible to increase the number of dimensions of the feature vector vₜ input to the controller 4, with respect to the number of state values sₜ obtained from the environment E. As a result, the amount of information used for inference in the inference device 100 can be increased. As a result, the operation of the apparatus (for example, the robot 2) can be efficiently controlled.

In addition, the feature amount extractor 3 includes one layer L1 or a plurality of layers L1, and the one layer L1 or at least one layer L1 of the plurality of layers L1 has the structure S that receives an input of the first vector x1, generates the second vector x2 by converting the first vector x1, generates the third vector x3 based on the first vector x1, generates the fourth vector x4 having a higher dimension than that of the first vector x1 by combining the second vector x2 and the third vector x3, and outputs the fourth vector x4. By using the structure S, it is possible to implement the feature amount extractor 3.

In addition, the structure S generates the third vector x3 by duplicating the first vector x1, and includes the learning type first converter 11 that converts the first vector x1 into the second vector x2. When the number of dimensions of the feature vector vₜ is increased, the operation amount in the inference device 100 can be reduced by using the duplication processing. As a result, inference efficiency in the inference device 100 can be improved.

In addition, the structure S generates the third vector x3 by converting the first vector x1, and includes the learning type first converter 11 that converts the first vector x1 into the second vector x2 and the non-learning type second converter 12 that converts the first vector x1 into the third vector x3. When the number of dimensions of the feature vector vₜ is increased, the operation amount in the inference device 100 can be reduced by using the non-learning type second conversion processing. As a result, inference efficiency in the inference device 100 can be improved.

In addition, the feature amount extractor 3 has a plurality of layers L1, and each of the plurality of layers L1 has the structure S. By increasing the number of layers L1 having the structure S, it is possible to further increase the amount of information used for inference in the inference device 100.

In addition, the apparatus control system 200 includes the inference device 100, the apparatus is the robot 2, the feature amount extractor 3 receives the input of the state value sₜ related to the environment E including the robot 2, and the controller 4 outputs the control amount Aₜ used for the control of the robot 2. By using the inference device 100, as described above, it is possible to efficiently control the operation of the robot 2 (for example, the robot arm).

### Second Embodiment

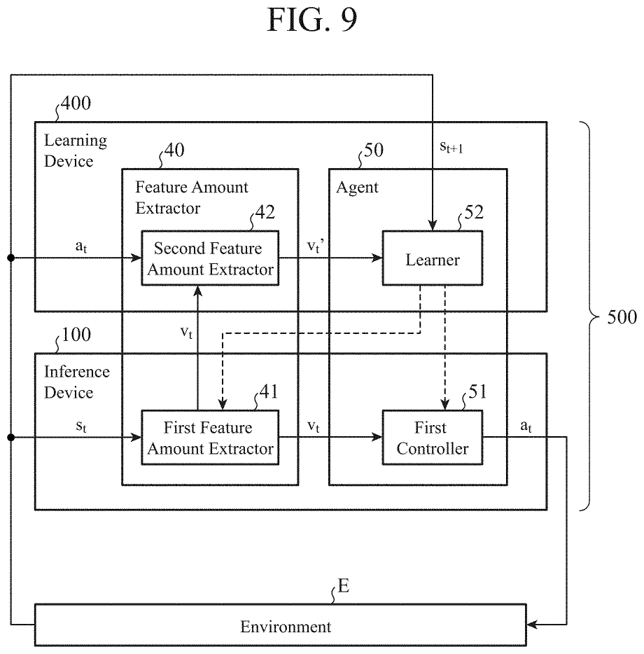

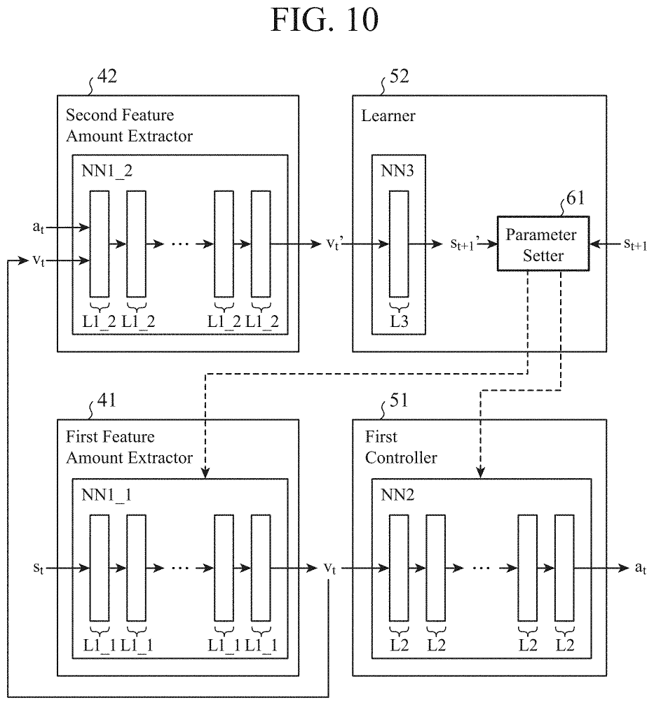

FIG. 9 is a block diagram showing a main part of a reinforcement learning system according to the second embodiment. FIG. 10 is an explanatory diagram illustrating main parts of a first feature amount extractor, a second feature amount extractor, a first controller, and a learner in the reinforcement learning system according to the second embodiment. The reinforcement learning system according to the second embodiment will be described with reference to FIGS. 9 and 10.

As illustrated in FIG. 9, a loop is formed by an environment E, a first feature amount extractor 41, and a first controller 51. The environment E outputs a state value (hereinafter, referred to as a “first state value”) sₜ indicating a state in the environment E. The first feature amount extractor 41 receives an input of the output first state value sₜ. The first feature amount extractor 41 outputs a feature vector (hereinafter, referred to as a “first feature vector”) vₜ corresponding to the input first state value sₜ. The first controller 51 receives an input of the output first feature vector vₜ. The first controller 51 outputs an action value aₜ corresponding to the input first feature vector vₜ. The environment E receives an input of the output action value aₜ. In the environment E, an action corresponding to the input action value aₜ is executed. As a result, the state in the environment E is updated. The environment E outputs a state value (hereinafter, referred to as a “second state value”) sₜ indicating the updated state. Hereinafter, a sign “sₜ+1” may be used for the second state value.

That is, the environment E illustrated in FIG. 9 corresponds to the environment E illustrated in FIG. 1. Therefore, the environment E illustrated in FIG. 9 includes the control device 1 and the robot 2 (not illustrated). The first feature amount extractor 41 illustrated in FIG. 9 corresponds to the feature amount extractor 3 illustrated in FIG. 1. The first controller 51 illustrated in FIG. 9 corresponds to the controller 4 illustrated in FIG. 1. In addition, the action value aₜ illustrated in FIG. 9 corresponds to the control amount Aₜ illustrated in FIG. 1.

As illustrated in FIG. 10, the first feature amount extractor 41 includes a neural network NN1_1. The neural network NN1_1 has a plurality of layers L1_1. Each of the layers L1_1 includes, for example, an FC layer. Here, each layer L1_1 has a structure S_1 similar to the structure S. Since the structure S_1 is similar to that described with reference to FIG. 4 in the first embodiment, illustration and description thereof are omitted. Since each layer L1_1 has the structure S_1, the number of dimensions of the first feature vector vₜ input to the first controller 51 is larger than the number of first state values sₜ input to the first feature amount extractor 41.

As illustrated in FIG. 10, the first controller 51 includes a neural network NN2. The neural network NN2 has a plurality of layers L2. Each of the layers L2 includes, for example, an FC layer. The first controller 51 corresponds to an “Actor” element in a so-called “Actor-Critic” algorithm.

As illustrated in FIG. 9, a second feature amount extractor 42 is provided in addition to the first feature amount extractor 41. The first feature amount extractor 41 and the second feature amount extractor 42 constitute a main part of the feature amount extractor 40.

The second feature amount extractor 42 receives an input of the first feature vector vₜ output from the first feature amount extractor 41. In addition, the second feature amount extractor 42 receives an input of the action value aₜ. The action value aₜ input to the second feature amount extractor 42 is, for example, output by the control device 1 in the environment E. The second feature amount extractor 42 outputs a feature vector (hereinafter, referred to as a “second feature vector”) vₜ′ corresponding to the input first feature vector vₜ and the input action value aₜ. Here, as described above, the first feature vector vₜ is a feature vector corresponding to the first state value sₜ. Therefore, the second feature vector vₜ′ is a feature vector corresponding to a set of the first state value sₜ and the action value aₜ.

As illustrated in FIG. 10, the second feature amount extractor 42 includes a neural network NN1_2. The neural network NN1_2 has a plurality of layers L1_2. Each of the layers L1_2 includes, for example, an FC layer. Here, each layer L1_2 has a structure S_2 similar to the structure S. Since the structure S_2 is similar to that described with reference to FIG. 4 in the first embodiment, illustration and description thereof are omitted. Since each of the layers L1_2 has the structure S_2, the number of dimensions of the second feature vector vₜ′ input to a learner 52 is larger than the total number of the number of dimensions of the first feature vector vₜ input to the second feature amount extractor 42 and the number of action values aₜ input to the second feature amount extractor 42.

As illustrated in FIG. 9, the learner 52 is provided in addition to the first controller 51. The first controller 51 and the learner 52 constitute a main part of an agent 50. The learner 52 corresponds to a “Critic” element in a so-called “Actor-Critic” algorithm.

That is, as illustrated in FIG. 10, the learner 52 includes a neural network NN3. The neural network NN3 includes one layer L3. The one layer L3 is configured by, for example, an FC layer. The neural network NN 3 receives an input of the second feature vector vₜ′ output from the second feature amount extractor 42. On the other hand, the neural network NN3 outputs a predicted value st+i' of the second state value sₜ+1. In other words, the neural network NN3 calculates the predicted value sₜ+1′ using the input second feature vector vₜ′.

Further, as illustrated in FIG. 10, the learner 52 includes a parameter setter 61. The parameter setter 61 receives an input of the predicted value sₜ+1′ output by the neural network NN3. In addition, the parameter setter 61 receives an input of the second state value sₜ+1 output by the control device 1 in the environment E. The parameter setter 61 updates a parameter P1 of the first feature amount extractor 41 and updates a parameter P2 of the first controller 51 by reinforcement learning using the input predicted value sₜ+1′ and the input second state value sₜ+1.

More specifically, the parameter setter 61 calculates a loss value L based on the difference between the predicted value sₜ+1′ and the second state value sₜ+1. The parameter setter 61 updates the parameters P1 and P2 so that the loss value L decreases.

The parameter P1 updated by the parameter setter 61 includes, for example, the number of layers L1_1 (hereinafter, referred to as “number of layers”) in the neural network NN1_1 and individual activation functions in the neural network NN1_1. Furthermore, the parameter P1 updated by the parameter setter 61 includes, for example, the structure of each first converter (not illustrated) in the neural network NN1_1. That is, the parameter P1 updated by the parameter setter 61 includes a plurality of parameters. Similarly, the parameter P2 updated by the parameter setter 61 includes a plurality of parameters.

As illustrated in FIG. 9, the first feature amount extractor 41 and the first controller 51 constitute a main part of the inference device 100. The second feature amount extractor 42 and the learner 52 constitute a main part of the learning device 400. Furthermore, the inference device 100 and the learning device 400 constitute a main part of a reinforcement learning system 500.

Since the hardware configuration of the main part of the inference device 100 is similar to that described with reference to FIG. 5 in the first embodiment, illustration and description thereof are omitted. That is, the functions of the first feature amount extractor 41 and the first controller 51 may be implemented by the processor 21 and the memory 22, or may be implemented by the dedicated processing circuit 23.

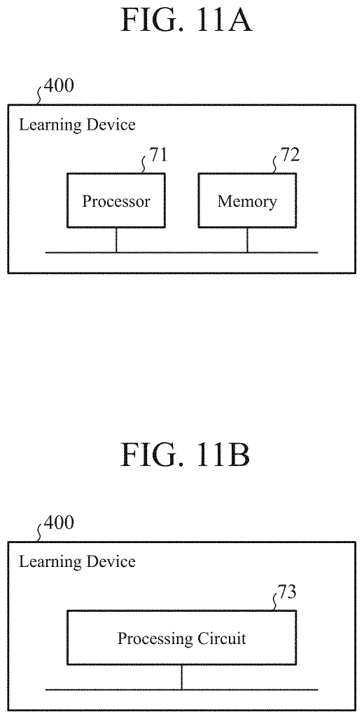

Next, a hardware configuration of the main part of the learning device 400 will be described with reference to FIG. 11.

As shown in FIG. 11A, the learning device 400 has a processor 71 and a memory 72. The memory 72 stores a program for implementing the functions of the second feature amount extractor 42 and the learner 52. The processor 71 reads and executes the program, thereby implementing the functions of the second feature amount extractor 42 and the learner 52.

Alternatively, as illustrated in FIG. 11B, the learning device 400 includes a processing circuit 73. In this case, the functions of the second feature amount extractor 42 and the learner 52 are implemented by the dedicated processing circuit 73.

Alternatively, for example, the learning device 400 has a processor 71, a memory 72, and a processing circuit 73 (not shown). In this case, some of the functions of the second feature amount extractor 42 and the learner 52 are implemented by the processor 71 and the memory 72, and the remaining functions are implemented by the dedicated processing circuit 73.

The processor 71 includes one or a plurality of processors. Each processor uses, for example, a CPU, a GPU, a microprocessor, a microcontroller, or a DSP.

The memory 72 includes one or a plurality of nonvolatile memories. Alternatively, the memory 72 includes one or a plurality of nonvolatile memories and one or a plurality of volatile memories. That is, the memory 72 includes one or a plurality of memories. Each memory is composed of, for example, a semiconductor memory, a magnetic disk, an optical disk, a magneto-optical disk, or a magnetic tape. More specifically, each volatile memory uses, for example, a RAM. In addition, each nonvolatile memory uses, for example, a ROM, a flash memory, an EPROM, an EEPROM, a solid state drive, a hard disk drive, a flexible disk, a compact disk, a DVD, a Blu-ray disk, or a mini disk.

The processing circuit 73 includes one or a plurality of digital circuits. Alternatively, the processing circuit 73 includes one or a plurality of digital circuits and one or a plurality of analog circuits. That is, the processing circuit 73 includes one or a plurality of processing circuits. Each processing circuit uses, for example, ASIC, PLD, FPGA, SoC, or system LSI.

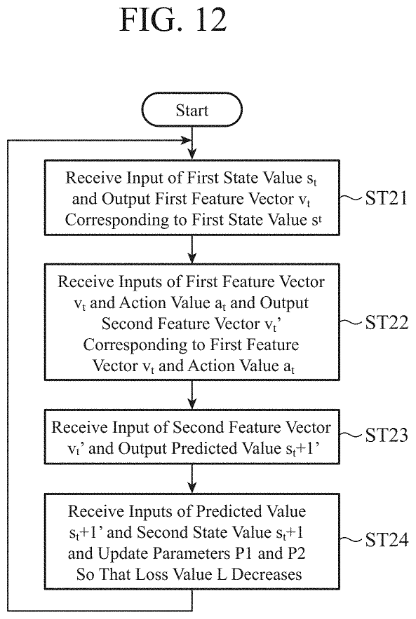

Next, the operation of the reinforcement learning system 500 will be described, while focusing on the operations of the first feature amount extractor 41, the second feature amount extractor 42, and the learner 52, with reference to the flowchart of FIG. 12. That is, an operation related to learning by the learning device 400 will be mainly described.

The processing illustrated in FIG. 12 is repeatedly executed in parallel with the processing illustrated in FIG. 7, for example. That is, the learning by the learning device 400 is repeatedly executed in parallel with, for example, the inference by the inference device 100 and the control by the control device 1. The processing of step ST21 illustrated in FIG. 12 corresponds to the processing of step ST1 illustrated in FIG. 7.

First, the first feature amount extractor 41 receives an input of the first state value sₜ and outputs the first feature vector vₜ corresponding to the input first state value sₜ (step ST21).

Next, the second feature amount extractor 42 receives inputs of the first feature vector vₜ and the action value aₜ, and outputs a second feature vector vₜ′ corresponding to the input first feature vector vₜ and action value aₜ (step ST22).

Next, the neural network NN3 in the learner 52 receives an input of the second feature vector vₜ′ and outputs the predicted value sₜ+1′ (step ST23).

Next, the parameter setter 61 in the learner 52 receives inputs of the predicted value sₜ+1′ and the second state value sₜ+1, and updates the parameters P1 and P2 so that the loss value L decreases (step ST24).

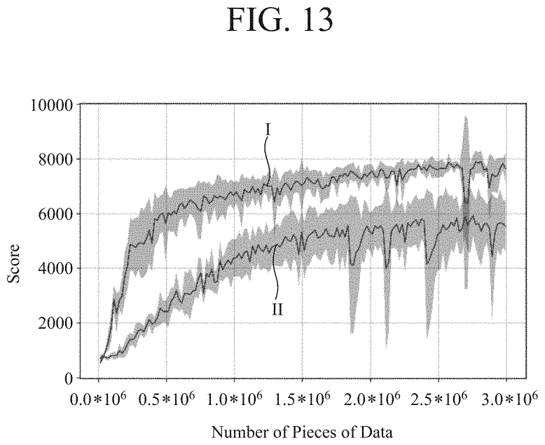

Next, effects obtained by using the feature amount extractor 40 will be described with reference to FIG. 13. More specifically, the effect of improving the learning efficiency will be mainly described.

Reference Literature 1 below discloses a so-called “Soft Actor-Critic” algorithm.

### REFERENCE LITERATURE 1

Tuomas Haarnoja, Aurick Zhou, Pieter Abbeel, and Sergey Levine, “Soft Actor-Critic: Off-Policy Maximum Entropy Deep Reinforcement Learning with a Stochastic Actor,” version 2, 8 Aug. 2018, URL: https://arxiv.org/pdf/1801.01290v2.pdf

Hereinafter, a reinforcement learning system S1 using an agent based on the “Soft Actor-Critic” algorithm described in Reference Literature 1 and including a feature amount extractor corresponding to the feature amount extractor 40 will be referred to as a “first reinforcement learning system”. Furthermore, a reinforcement learning system S2 using an agent based on the “Soft Actor-Critic” algorithm described in Reference Literature 1 and not including a feature amount extractor corresponding to the feature amount extractor 40 will be referred to as a “second reinforcement learning system”.

That is, the first reinforcement learning system S1 corresponds to the reinforcement learning system 500 according to the second embodiment. On the other hand, the second reinforcement learning system S2 corresponds to a conventional reinforcement learning system.

In the first reinforcement learning system S1, the feature amount extractor corresponding to the first feature amount extractor 41 has eight layers. Each of the eight layers has the same structure as the structure S. As a result, the number of dimensions of the vector output by the feature amount extractor (that is, the number of dimensions of the feature vector input to the “Actor” element) is increased by 240, with respect to the number of dimensions of the vector input to the feature amount extractor (that is, the number of dimensions of the feature vector corresponding to the state value sₜ).

Furthermore, in the first reinforcement learning system S1, the feature amount extractor corresponding to the second feature amount extractor 42 has 16 layers. Each of the 16 layers has the same structure as the structure S. As a result, the number of dimensions of the vector output by the feature amount extractor (that is, the number of dimensions of the feature vector input to the “Critic” element) is increased by 480, with respect to the number of dimensions of the vector input to the feature amount extractor (that is, the number of dimensions of the feature vector corresponding to a set of the state value sₜ and the action value aₜ).

A characteristic line I in FIG. 13 illustrates an example of an experimental result using the first reinforcement learning system S1. In addition, a characteristic line II in FIG. 13 illustrates an example of an experimental result using the second reinforcement learning system S2. These experimental results are based on a so-called “Ant-v2” benchmark.

The horizontal axis in FIG. 13 corresponds to the number of pieces of data. The number of pieces of data corresponds to the number of times of execution of inference when learning and inference by each of the reinforcement learning systems S1 and S2 are repeatedly executed. That is, the number of pieces of data corresponds to the cumulative value of the number of values (including the state value sₜ) obtained from the environment E. The vertical axis in FIG. 13 corresponds to a score. The score corresponds to a reward value rₜ obtained by an action based on a result of each inference when learning and inference by each of the reinforcement learning systems S1 and S2 are repeatedly executed.

That is, the characteristic line I indicates the learning characteristic in the first reinforcement learning system S1. In addition, the characteristic line II indicates the learning characteristic in the second reinforcement learning system S2.

As illustrated in FIG. 13, by using the first reinforcement learning system S1, it is possible to improve the score for the number of pieces of data, as compared with the case of using the second reinforcement learning system S2. This indicates that in achieving the inference corresponding to the predetermined reward value rₜ, the number of interactions between the agent 50 and the environment E can be reduced by using the feature amount extractor 40.

In addition, as illustrated in FIG. 13, by using the first reinforcement learning system S1, it is possible to improve the maximum value of the score, as compared with the case of using the second reinforcement learning system S2. This indicates that inference corresponding to a higher reward value rₜ can be achieved by using the feature amount extractor 40.

As described above, by using the feature amount extractor 40, it is possible to improve learning efficiency. In addition, inference efficiency can be improved.

Next, a modification of the reinforcement learning system 500 will be described.

The number of layers L1_1 in the neural network NN1_1 and the number of layers L1_1 having the structure S_1 are not limited to the above specific examples. The number is only required to be set so that the number of dimensions of the feature vector vₜ input to the first controller 51 is larger than the number of state values sₜ input to the first feature amount extractor 41.

For example, as described above, the neural network NN1_1 may have the plurality of layers L1_1, and each of the plurality of layers L1_1 may have the structure S_1. Alternatively, for example, the neural network NN1_1 may have one layer L1_1 instead of the plurality of layers L1_1, and the one layer L1_1 may have the structure S_1.

Alternatively, for example, the neural network NN1_1 may have a plurality of layers L1_1, and each of two or more selected layers L1_1 among the plurality of layers L1_1 may have the structure S_1. In this case, each of the remaining one or more layers L1_1 among the plurality of layers L1_1 may not have the structure S_1.

Alternatively, for example, the neural network NN1_1 may have a plurality of layers L1_1, and a selected one of the plurality of layers L1_1 may have the structure S_1. In this case, each of the remaining one or more layers L1_1 among the plurality of layers L1_1 may not have the structure S_1.

Furthermore, the number of layers L1_2 in the neural network NN1_2 and the number of layers L1_2 having the structure S_2 are not limited to the above specific examples. The number is only required to be set so that the number of dimensions of the second feature vector vₜ′ input to the learner 52 is larger than the total number of the number of dimensions of the first feature vector vₜ input to the second feature amount extractor 42 and the number of action values aₜ input to the second feature amount extractor 42.

For example, as described above, the neural network NN1_2 may have the plurality of layers L1_2, and each of the plurality of layers L1_2 may have the structure S_2. Alternatively, for example, the neural network NN1_2 may have one layer L1_2 instead of the plurality of layers L1_2, and the one layer L1_2 may have the structure S_2.

Alternatively, for example, the neural network NN1_2 may have a plurality of layers L1_2, and each of two or more selected layers L1_2 among the plurality of layers L1_2 may have the structure S_2. In this case, each of the remaining one or more layers L1_2 among the plurality of layers L1_2 may not have the structure S_2.

Alternatively, for example, the neural network NN1_2 may have a plurality of layers L1_2, and a selected one of the plurality of layers L1_2 may have the structure S_2. In this case, each of the remaining one or more layers L1_2 among the plurality of layers L1_2 may not have the structure S_2.

Furthermore, the hardware of the learning device 400 may be configured integrally with the hardware of the inference device 100. That is, the processor 71 illustrated in FIG. 11A may be configured integrally with the processor 21 illustrated in FIG. 5A. The memory 72 illustrated in FIG. 11A may be configured integrally with the memory 22 illustrated in FIG. 5A. The processing circuit 73 illustrated in FIG. 11B may be configured integrally with the processing circuit 23 illustrated in FIG. 5B.

As described above, in the learning device 400 for the inference device 100, the inference device 100 including the first feature amount extractor 41 that receives the input of the first state value sₜ related to the environment E including both the control device 1 and the apparatus (for example, the robot 2) controlled by the control device 1, and outputs the first feature vector vₜ corresponding to the first state value sₜ and having a higher dimension than that of the first state value sₜ, the learning device 400 includes: the second feature amount extractor 42 that receives inputs of the first feature vector vₜ and the action value aₜ related to the environment E and outputs the second feature vector vₜ′ corresponding to the first feature vector vₜ and the action value aₜ and having a higher dimension than those of the first feature vector vₜ and the action value aₜ; and the learner 52 that receives inputs of the second feature vector vₜ′ and the second state value sₜ+1 related to the environment E, and updates the parameter P1 of the first feature amount extractor 41 by using the second feature vector vₜ′ and the second state value sₜ+1. By using the feature amount extractor 40, it is possible to improve learning efficiency as illustrated in FIG. 13. In addition, inference efficiency can be improved.

Further, each of the first feature amount extractor 41 and the second feature amount extractor 42 has one layer L1 or a plurality of layers L1, and the one layer L1 or at least one layer L1 of the plurality of layers L1 has a structure S that receives an input of a first vector x1, generates a second vector x2 by converting the first vector x1, generates a third vector x3 based on the first vector x1, generates a fourth vector x4 having a higher dimension than that of the first vector x1 by combining the second vector x2 and the third vector x3, and outputs the fourth vector x4. By using the structure S, it is possible to achieve the feature amount extractor 40.

In addition, the learner 52 calculates the predicted value sₜ+1′ of the second state value sₜ+1 using the second feature vector vₜ′, and updates the parameter P1 so that the loss value L based on the difference between the predicted value sₜ+1′ and the second state value sₜ+1 decreases. As a result, the learner 52 corresponding to the learning of the first feature amount extractor 41 can be achieved.

In addition, the parameter P1 includes the number of layers in the first feature amount extractor 41 and individual activation functions in the first feature amount extractor 41. As a result, the learner 52 corresponding to the learning of the first feature amount extractor 41 can be achieved.

### Third Embodiment

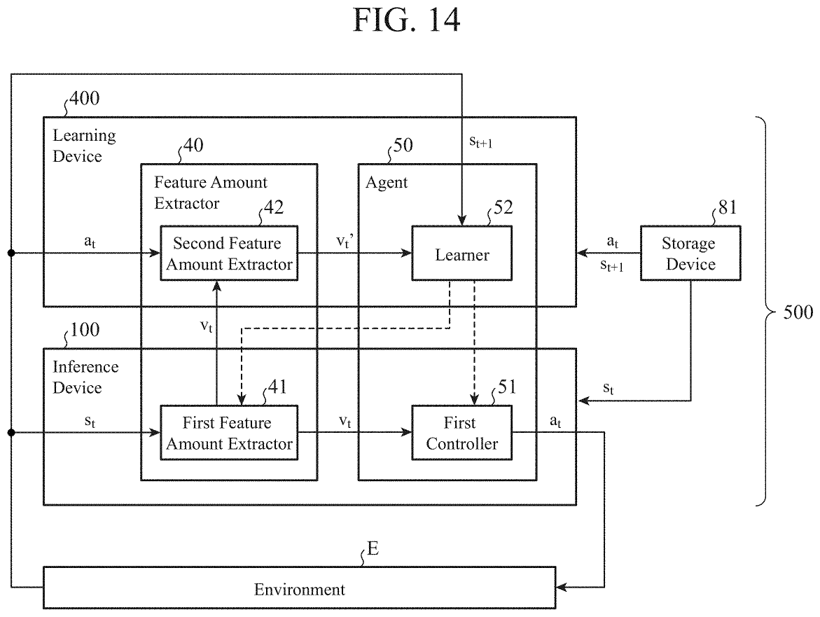

FIG. 14 is a block diagram showing a main part of a reinforcement learning system according to the third embodiment. With reference to FIG. 14, the reinforcement learning system according to the third embodiment will be described. In FIG. 14, the same reference numerals are given to the same blocks as those illustrated in FIG. 9, and the description thereof will be omitted.

As illustrated in FIG. 14, a reinforcement learning system 500 according to the third embodiment includes a storage device 81 in addition to the inference device 100 and the learning device 400. The storage device 81 stores a set of the first state value sₜ, the corresponding action value aₜ, and the corresponding second state value sₜ+1. More specifically, a plurality of sets of values (sₜ, aₜ, sₜ+1) is stored. These values (sₜ, aₜ, sₜ+1) are collected using another controller (hereinafter, referred to as a “second controller”) different from the first controller 51. The second controller is, for example, a virtual controller that behaves randomly with respect to the environment E.

The storage device 81 outputs the stored value (sₜ, aₜ, sₜ+1). When learning by the learning device 400 is executed, a value (sₜ, aₜ, sₜ+1) output by the storage device 81 may be used, instead of a value (sₜ, aₜ, sₜ+1) output by the control device 1 in the environment E.

That is, in step ST21 illustrated in FIG. 12, instead of receiving the input of the first state value sₜ output by the control device 1 in the environment E, the first feature amount extractor 41 may receive the input of the first state value sₜ output by the storage device 81. Furthermore, in step ST22 illustrated in FIG. 12, instead of receiving the input of the action value aₜ output by the control device 1 in the environment E, the second feature amount extractor 42 may receive the input of the action value aₜ output by the storage device 81. Furthermore, in step ST24 illustrated in FIG. 12, instead of receiving the input of the second state value sₜ+1 output by the control device 1 in the environment E, the parameter setter 61 in the learner 52 may receive the input of the second state value sₜ+1 output by the storage device 81.

In this case, the processing illustrated in FIG. 12 may be executed in advance before the processing illustrated in FIG. 7 is executed. That is, learning by the learning device 400 may be executed in advance before inference by the inference device 100 and control by the control device 1 are executed.

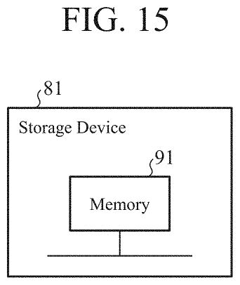

Next, a hardware configuration of the main part of the storage device 81 will be described with reference to FIG. 15.

As illustrated in FIG. 15, the storage device 81 includes a memory 91. The function of the storage device 81 is implemented by the memory 91. The memory 91 includes one or a plurality of nonvolatile memories. Each nonvolatile memory is composed of, for example, a semiconductor memory, a magnetic disk, an optical disk, a magneto-optical disk, or a magnetic tape. More specifically, each nonvolatile memory is composed of, for example, a ROM, a flash memory, an EPROM, an EEPROM, a solid state drive, a hard disk drive, a flexible disk, a compact disk, a DVD, a Blu-ray disk, or a mini disk.

Note that the hardware of the storage device 81 may be configured integrally with the hardware of the learning device 400. That is, the memory 91 illustrated in FIG. 15 may be configured integrally with the memory 72 illustrated in FIG. 11A.

Furthermore, the hardware of the storage device 81 may be configured integrally with the hardware of the inference device 100. That is, the memory 91 illustrated in FIG. 15 may be configured integrally with the memory 22 illustrated in FIG. 5A.

In addition, the reinforcement learning system 500 according to the third embodiment can adopt various modifications similar to those described in the second embodiment.

As described above, the inference device 100 includes the first controller 51 that receives the input of the first feature vector vₜ and outputs the action value aₜ corresponding to the first feature vector vₜ, and the first state value sₜ input to the first feature amount extractor 41, the action value aₜ input to the second feature amount extractor 42, and the second state value sₜ+1 input to the learner 52 are collected using the second controller different from the first controller 51. By using the second controller, it is possible to execute learning by the learning device 400 in advance before inference by the inference device 100 and control by the control device 1 are executed.

In addition, the second controller behaves randomly with respect to the environment E. As a result, multiple sets of values (sₜ, aₜ, sₜ+1) different from each other can be collected.

It should be noted that in the invention of the present application, it is possible to freely combine the embodiments, modify any constituent element of each embodiment, or omit any constituent element in each embodiment within the scope of the invention.

### INDUSTRIAL APPLICABILITY

The inference device, the apparatus control system, and the learning device of the present invention can be used for operation control of a robot, for example.

### REFERENCE SIGNS LIST

1: control device, 2: robot, 3: feature amount extractor, 4: controller, 11: first converter, 12: second converter, 21: processor, 22: memory, 23: processing circuit, 31: processor, 32: memory, 33: processing circuit, 40: feature amount extractor, 41: first feature amount extractor, 42: second feature amount extractor, 50: agent, 51: first controller, 52: learner, 61: parameter setter, 71: processor, 72: memory, 73: processing circuit, 81: storage device, 91: memory, 100: inference device, 200: apparatus control system, 300: robot system, 400: learning device, 500: reinforcement learning system

1. An inference device, comprising:
feature amount extracting circuitry to receive an input of a state value related to an environment including both a control device and an apparatus controlled by the control device, and output a feature vector that corresponds to the state value and has a higher dimension than that of the state value; and
controlling circuitry to receive an input of the feature vector and output a control amount corresponding to the feature vector, wherein the feature amount extracting circuitry includes one layer or a plurality of layers, and
the one layer or at least one of the plurality of layers has a structure that receives an input of a first vector, generates a second vector by converting the first vector, generates a third vector based on the first vector, generates a fourth vector having a higher dimension than that of the first vector by combining the second vector and the third vector, and outputs the fourth vector.

2. The inference device according to claim 1, wherein the structure generates the third vector by duplicating the first vector, and includes learning type first converting circuitry to convert the first vector into the second vector.

3. The inference device according to claim 1, wherein the structure generates the third vector by converting the first vector, and includes learning type first converting circuitry to convert the first vector into the second vector and non-learning type second converting circuitry to convert the first vector into the third vector.

4. The inference device according to claim 1, wherein the feature amount extracting circuitry has the plurality of layers, and each of the plurality of layers has the structure.

5. An apparatus control system, comprising the inference device according to claim 1, wherein
the apparatus is a robot,
the feature amount extracting circuitry receives an input of the state value related to the environment including the robot, and
the controlling circuitry outputs the control amount used for control of the robot.

6. A learning device for an inference device, the inference device including first feature amount extracting circuitry to receive an input of a first state value related to an environment including both a control device and an apparatus controlled by the control device, and output a first feature vector that corresponds to the first state value and has a higher dimension than that of the first state value, the learning device comprising:
second feature amount extracting circuitry to receive inputs of the first feature vector and an action value related to the environment, and output a second feature vector that corresponds to the first feature vector and the action value and has a higher dimension than those of the first feature vector and the action value; and
learning circuitry to receive inputs of the second feature vector and a second state value related to the environment, and update a parameter of the first feature amount extracting circuitry by using the second feature vector and the second state value.

7. The learning device according to claim 6, wherein
each of the first feature amount extracting circuitry and the second feature amount extracting circuitry has one layer or a plurality of layers, and
the one layer or at least one of the plurality of layers has a structure that receives an input of a first vector, generates a second vector by converting the first vector, generates a third vector based on the first vector, generates a fourth vector having a higher dimension than that of the first vector by combining the second vector and the third vector, and outputs the fourth vector.

8. The learning device according to claim 6, wherein the learning circuitry calculates a predicted value of the second state value by using the second feature vector, and updates the parameter so that a loss value based on a difference between the predicted value and the second state value decreases.

9. The learning device according to claim 6, wherein
the inference device includes first controlling circuitry to receive an input of the first feature vector and output the action value corresponding to the first feature vector, and
the first state value input to the first feature amount extracting circuitry, the action value input to the second feature amount extracting circuitry, and the second state value input to the learning circuitry are collected by using second controlling circuitry different from the first controlling circuitry.

10. The learning device according to claim 9, wherein the second controlling circuitry behaves randomly with respect to the environment.

11. The learning device according to claim 6, wherein the parameter includes the number of layers in the first feature amount extracting circuitry and individual activation functions in the first feature amount extracting circuitry.
